(19) United States
(12) Patent Application Publication
(10) Pub. No.: US 2022/0084343 A1
(43) Pub. Date: Mar. 17, 2022

(54) MULTIFUNCTION SMART DOOR LOCK

(71) Applicants: Sanjay Kumar Biswal, Faridabad (IN); Dinesh Dahiya, New Delhi (IN); Manisha Nagariya, Indore (IN); Sanjay Nanda, New Delhi (IN)

(72) Inventors: Sanjay Kumar Biswal, Faridabad (IN); Dinesh Dahiya, New Delhi (IN); Manisha Nagariya, Indore (IN); Sanjay Nanda, New Delhi (IN)

(21) Appl. No.: 17/474,857

(22) Filed: Sep. 14, 2021

Related U.S. Application Data
(60) Provisional application No. 63/077,755, filed on Sep. 14, 2020.

(51) Int. Cl. G07C 9/37; G06F 21/32; G06K 9/00; G06T 7/20; H04N 5/225; H04N 5/33

(52) U.S. Cl. CPC G07C 9/37; G06F 21/32; G06K 9/00288; H04N 5/33; G06T 7/20; H04N 5/2251; G06K 9/00268

(57) ABSTRACT

The present invention is a multifunction smart door lock to enhance security by using facial recognition and multi-sensing detection system integrated with a camera and implemented through advanced image processing algorithms which secures door entrance based on defined users and keeps census in defined premises on a real time basis. The system is a combination of hardware and software cloud-based applications including an image input unit, a control unit, a display unit, a battery-operated power source and a servomotor to actuate the door opening and closing. The system further has wired or wireless transmission devices capable of being integrated with smart home systems and creating personalized experience for each user based on their specific preferences.

### CROSS-REFERENCE TO RELATED APPLICATION

This application claims the benefit of priority of U.S. Provisional Patent Application No. 63/077,755 filed on Sep. 14, 2020.

### FIELD OF THE INVENTION

The present invention relates in general to the smart door locks and in particular to a multifunction smart door lock system to enhance security by using apparatus, systems, methods, and related computer program products for providing home security. More particularly, this patent specification relates to a plurality of devices, including intelligent, multi-sensing, network-connected devices, that communicate with each other and/or with a central server or a cloud-computing system to provide any of a variety of useful security system in door lock.

### BACKGROUND OF THE INVENTION

Nowadays, providing a security system for houses has become a vital research in which the latest technologies are being adopted to serve this purpose. Securing homes has become one of the concerning issues that facing many people. Such concept aims to turn the home into a smart in which different tasks especially monitoring can be performed remotely. Home automation system is a computer-based application that has the ability to connect different electronic devices. Recently, electronic door lock systems are one of the most popular security systems that is being installed for many residents and business places. Such system is based on a pattern recognition technology where the individuals' faces are being analyzed in order to identify their personalities.

Access security is one of the most worrying features of people. Companies, residential properties, agencies, office buildings, shopping malls, hotels, daycares, etc. need to have a reliable access control system. In recent years, a large amount of safety monitoring equipment is invented to increase the public safety monitoring aspects. Buildings are equipped with public safety video systems to provide a controlled and safe entrance. With the development of computer technology and various sensor technology, the various identification systems based on biological characteristic (comprising face, iris, retina, sound, fingerprint, palmprint, blood vessel, DNA etc.) have been raised. In view of the advantage of these unique systems, recognition of face is considered to one can widely use optimal biometrics identification technology.

Currently smart locks available in the market with biometric access & application are based on smart phone. However, those with Facial recognition are memory chip based. The problem with current available smart door locks is that they are not computerized, they have very few features and not smart enough. They are not able to integrate with third party software to enhance security, reduce cost of manpower, attendance facility and home automation integration and etc.

In addition, in the existing access control systems, such as a fingerprint reader installed in a door to input and receive a fingerprint of a user, directly control the opening and closing of the corresponding door and are vulnerable to moisture, temperature, pressure and the like. The door control systems in card form have further disadvantages that the card may inadvertently be lost, information in the card may be decrypted, and cause large hidden danger to safety.

### SUMMARY OF THE INVENTION

In one aspect, the present invention is a multifunction door lock system for detection and control securely and effectively the entry of a person through a passageway, the system comprising facial detecting means to detect, based on facial image data whether the person attempting to pass through the door is or is not authorized to pass. The door lock system has a data recording means to record facial data in advance. The facial detecting means detect the authorized person at the door by comparing the on-site facial image taken by a camera with the recorded facial data in the data recording means.

The facial detecting means comprises of an input unit, a control unit to control the operation of the system, an output unit, a battery operated power source for operation of the various parts of the system, and a door opening and closing unit. The input unit comprising a key pad, an image input unit and a sensor unit. The image input unit is at least a camera to capture one or more image of a person and generate an authentication approval to grant a permission for entry the door. The Camera further detects motion of an object and analyzes the captured images to determine a presence of a person and whether the person is authorized or unauthorized.

The door lock further has multi-sensing detector means to sense the existence of a person or an object approaching the door. The multi-sensing detector means comprising: at least a temperature sensor; a motion sensor; a heat sensor, a pressure sensor and an audio sensor to detect the presence of an object. The multi-sensing detectors operate in respect to the camera to sense a person approaching the door based on the temperature. In one aspect the temperature detector provides a Infrared Thermometer system. The pressure sensor in conjunction with said camera sense a pressure variation pattern to determine the activity of an object in front of a door or approaching a door.

The sensors are integrated in said camera for viewing and detecting an approach of a person and analyze with respect to captured images to determine a presence of a person.

The system further has a door opening and closing unit which is a servomotor to actuate the door opening and closing.

A non-transitory computer readable storage medium storing one or more programs, the one or more programs comprising instructions, which, when executed by a computing system comprising one or more processors and one or more sensors and a door opening and closing unit cause the computing system to detect and control securely and effectively the entry of a person through a passageway.

The face recognition system of the present invention is implemented through advanced image processing algorithms such as intelligent autonomous learning function geometric feature extraction using a neural network. This system distinguishes between the authorized and unauthorized persons by reading the face information of the passengers through the face recognition function and performs the access control function by interlocking with the door lock device.

This system has the capability of being integrated with smart home systems and creating personalized experience for each user based on their specific preferences. The multifunction smart door lock includes various features as follow: authentication through cloud-based application, attendance keeping, event access, mobile ID, surveillance, and home automation.

Multifunction smart door lock is a combination of electrical hardware lock+IoT based application (software cording)—Cloud based Application. The lock has a facial recognition and authentication system each having access control through cloud-based applications, attendance recording for every access and activities monitoring.

In another aspect, the present invention is a multifunction smart door lock with facial recognition that works in real time with a CCTV surveillance.

In another aspect, the present invention is a multifunction smart door lock with facial recognition that works along with body temperature detection.

In another aspect, the present invention is a multifunction smart door lock with a virtual speaking device which greets people on arrival/departure and specific occasion along with the basis of available data.

In another aspect, the present invention is a multifunction smart door lock with a camera specifically enabled with various functionalities.

In another aspect, the present invention is a multifunction smart door lock capable of integration with third party software's such as Alexa, Google etc. devices and can perform with them without any limitation.

In another aspect, the present invention is a multifunction smart door lock with capability to speak to the unknown visitor such as delivery agents etc. with even a long distance via phone enabled feature.

In another aspect, the present invention is a multifunction smart door lock with voice recognition feature of specific visitors to allow them to gain access after the approval even if they are not visible in the video or the image captured by the device.

In another aspect, the present invention is a multifunction smart door lock with capability to integrate with the fire alarm or any other real time emergency which allows device to immediately notify the nearest police, fire, and rescue team along with the owner.

In another aspect, the present invention is a multifunction smart door lock with capability to allow users to edit data and gave them access with even a picture is uploaded in the device with the phone after the approval of the admin.

In another aspect, the present invention is a multifunction smart door lock with a phone which can be installed in different places and is not limited to be installed at door. For example, the phone can be installed in wardrobes, safe etc. and allocate different access control to different users. This feature provides more security to the door lock system.

Therefore, it is an object of the present invention that unlike the most of other devices available in the market which are basically limited to identify the person with a short-range video detection, the present invention is free from this limitation and can be installed at big retail chains and many more places to identify the customer behavior pattern.

It is therefore an object of the present invention to provide a secure smart door lock system being used in places with vulnerable people such as senior residences, pre-school settings, rehabilitation centers and the like, where supervisors must have real time census of the occupants.

It is another object of the present invention to provide a smart door lock system with activity tracking and reporting for warehousing, manufacturing, and business activities, where security and other performance indicators are very critical.

It is another object of the present invention to provide a high-level facial recognition door lock system, capable of accurately recognizing functions in various environments by developing a high-precision, safe and reliable advanced facial recognition algorithm.

It is another object of the present invention to enhance security by facial recognition, attendance keeping, easy access of data for each entry and exit, reduce the cost of manual mode of security, secure the area which are not accessible permitted.

It is another object of the present invention to provide a system that invokes a number of advanced technologies such as IoT, AI, machine learning, neural networks, big data analytics all with a common goal to make things easier, self-supervising and interoperable.

It is another object of the present invention which has an easy access to data over cloud/information sharing through Smart phone/PDA and can be integrated with home automation systems

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates a multifunction smart door lock in accordance to a smart-home environment and a computer program with which the smart-home environment products may be applicable, according to at least one embodiment;

FIG. 2A shows the multifunction smart door lock according to the present invention;

FIG. 2B shows the various parts of the multifunction smart door lock system;

FIG. 3 is a simplified block diagram illustrating components of a multifunction smart door lock, according to at least one embodiment of the present invention;

FIG. 4 is a flowchart showing the configuration and processing procedure of the face recognition according to the present invention, and

FIG. 5 is a block diagram illustrating the entire system for the multifunction smart door lock according to an embodiment of the present invention.

### DETAILED DESCRIPTION OF PREFERRED EMBODIMENTS

Smart-home networks provide automated control of devices such as security systems, lighting systems, heatings etc. which may include control systems that a person may use to control of various devices and systems in the home. A non-transitory computer readable storage medium may be provided storing one or more programs, the one or more programs including instructions, which, when executed by a computing system may cause the computing system to detect, the one or more processors of the computing system.

The multifunction smart door lock is described within the smart-home environment but is not limited and may be applicable to environments, such as, for example, hotels, retail stores, factories, office buildings, daycares, etc. It is also to be understood that the term door lock may be any structure of any suitable size and shape positioned with respect to a door frame. Many smart devices, including intelligent, multi-sensing, network-connected devices may communicate with each other and/or with a central server or a cloud-computing system.

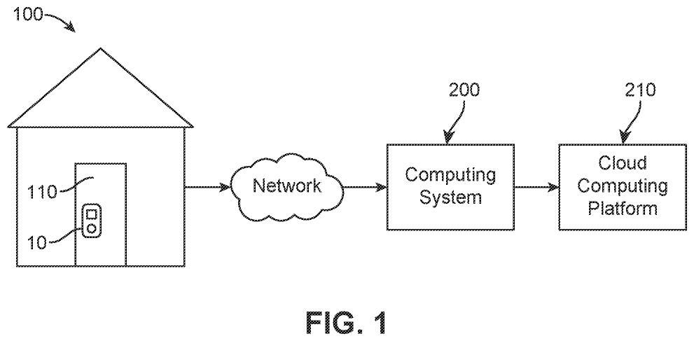

FIG. 1 illustrates an example of a smart-home environment 100 including a plurality of devices that can integrate with each other and with a central server of a computing system 200 of a cloud-computing platform 210. Each of the network-connected smart devices can communicate with the remote servers or cloud computing platform 210.

The smart home 100 provides a smart door 110 which may include a multifunction smart door lock 10 for detection and control the entry and may enable the computing system 200 to more securely and more effectively control the entry the door 110. The multifunction smart door-lock 10 detects a user's approach to or departure from a location, announce a person's approach or departure via aural or visual methods, and/or control settings on a security system.

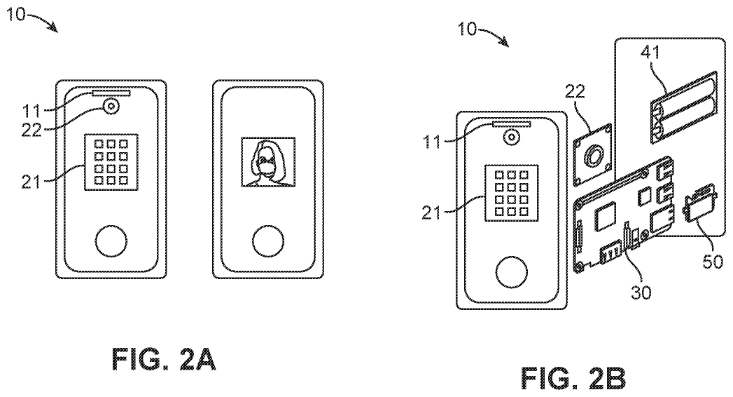

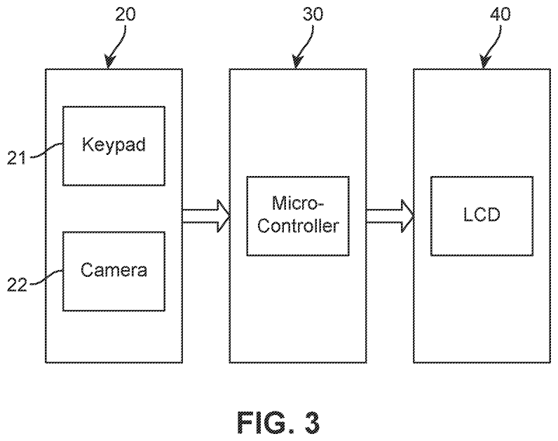

According to FIGS. 2 and 3 a multifunction smart door lock 10 includes an input unit 20, a processing unit 30 and an output unit 40. The input unit 20 comprising a key pad 21 and an image input unit 22. The keypad 21 can be a 4×3 Matrix Membrane Keypad or other suitable keypad. The image input unit 22 is a Pi camera. The control unit 30 controls the operation of the system and comprises a microcontroller selected from but not limited to a Raspberry Pi processor.

The output unit 40 is a LCD display. A battery operated power source 41 is provided for operation of the various parts of the system. In some embodiments, the battery could be a rechargeable battery, such as a rechargeable Lithium-Ion battery. While the smart door lock 10 is operated in accordance with the smart door 110, it may be connected to steady and reliable power from smart-home environment 100. The smart door lock 10 further includes a door opening and closing unit 50 which has a servomotor to actuate the door opening and closing unit.

The Input unit 20 is to input the image of the person and and generate an authentication approval to grant a permission for entry the door. The output unit 40 basically includes access to the door and may include a user interface of any suitable type, such as one or more visual displays, light-emitting diode (LED), or any other suitable display, touchscreen or any suitable display, and/or button input capabilities, audio speaker, microphone, and/or the like. User interface may additionally or alternatively be configured to take a variety of forms, including, but not limited to, a touch pad, touch screen, 3-dimensional input and/or output interface.

All the operations of the multifunction door lock 10 are done by the control unit 30 which is a micro-controller including but not limited to a Raspberry Pi which can be applied to an electronic structure and programming network work. It controls camera pi 22, keypad 21 and communication between server and all the important processes including verification of the user ID. All the operations are done by the control unit 30 which includes sending SMS and images to the user and check that the person is authorized to enter the house.

The keypad 21 is to insert the code at the door to compare the inserted ID with the pre-existing IDs in the database of the system. The control unit 30 sends the inserted-ID to the server for verification. Server then searches for pre-existing ID and if the ID exists in the database then server sends signal back to control unit 30 as a response and at the same time activates the camera 22 and take shots of the user at the door and sends it through email to the user.

The system uses face recognition technique to compare the image with the existing database and in this way the person is allowed to enter or not to enter the door. The camera 22 acquires the continuous image including the face of the person through the built-in camera and transmits the acquired image to the control unit 30. The control unit 30 is implemented as a microcontroller including an image processing module and receives facial image data in real time to perform image processing algorithms such as face detection, face standardization, and face recognition. In the present invention, a high-speed visual processing can be performed using appropriate hardware and software, and the whole system is effectively constituted, realizing the recognition algorithm in real time.

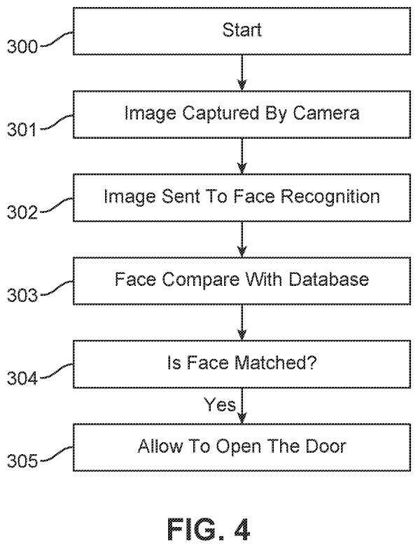

FIG. 4 shows the configuration and processing procedure of the face recognition according to the present invention. The processes is shown in steps 300 to 305. In the first step 301 the processing unit is configured to capture the image of the face when the camera is automatically searched by the image acquisition step and when a person is within the shooting range on the LCD monitor of the image input unit. Based on the detection result in the processing step, the face image is processed to meet the feature extraction requirement. The detection function by the face recognition system includes visual function, pixel statistical function, face image conversion ratio function and face image algebra function. The user further is requested to enter a passcode on the display unit 30 which identifies the users information pre-stored in the database of the system.

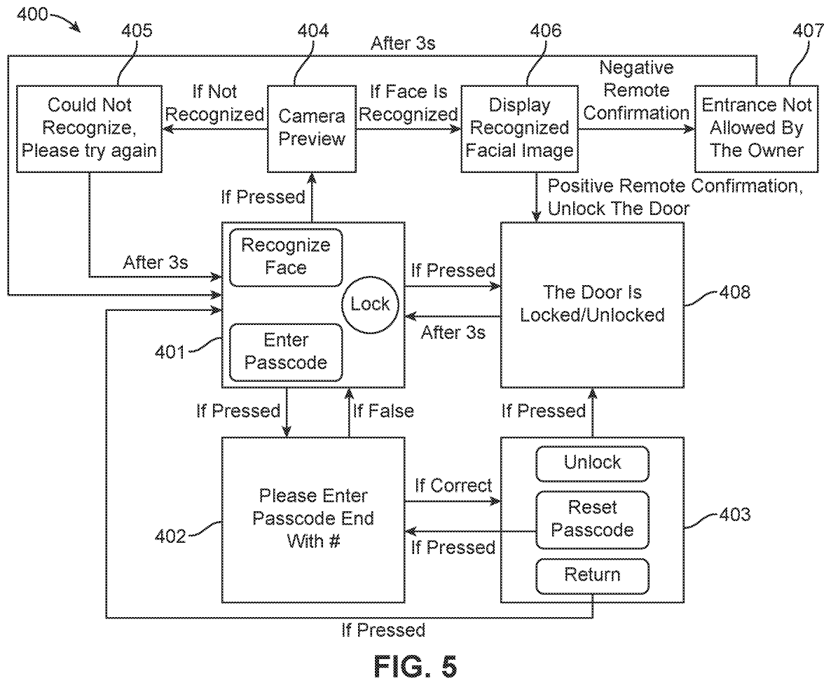

According to FIG. 5 the face matching and recognition steps compare the currently inputted image with the feature information of the corresponding stored face in the person information database constructed in advance in the face image, and outputs the similarity of each of the registered image and the currently input image. The output similarity is compared with the threshold value to determine the final recognition result. If the final recognition result fails to authenticate, it provides the user with a response such as a voice message or a notification to notify the passenger that the entrance is not allowed.

The system may store a list of registered individuals of the home. When a person who is not recognized by the cloud-computing system 210 as a registered occupant or guest, cloud-computing system may log that person's presence. The extracted facial feature data is matched with the template stored in the database.

The steps 400 to 407 show the procedure. The door is interlocked with the door lock and receives the recognition result and perform opening and closing of the door. Door opening/closing then decides whether to authenticate the user according to the result obtained by face recognition. If the user succeeds in authentication, the door is opened by manipulating the operation of the control unit. If the user fails to authenticate, the user is notified.

A user can remotely interact with smart door lock using a computer (e.g., a desktop computer, laptop computer, or tablet) or other portable or any other suitable type of user electronic device (e.g., a smartphone). Some or all of the occupants (e.g., individuals who live in the home) can register their device with the smart-home environment 100 to remotely control the network-connected smart door lock 10.

Turning now to FIGS. 1 to 3, the smart door 110 provides the functionality to serve as a home entryway unit, such by providing various functionalities, including, but not limited to, a door lock functionality or other visitor arrival functionality, audio/visual visitor announcement functionality, access enabling/restricting functionality through a door and/or the like. The smart door 110 may be enhanced with network-connectedness and/or a variety of multi-sensing capabilities to accommodate additional functionalities.

Referring to FIG. 2A and 2B again the multifunction smart door lock 10 may include smart entry multi-sensing detector unit 11 integrated with the camera 22 to sense the existence of a person or an object approaching the door. In one embodiment the detector is based on body temperature measurement which combines thermal and visible light video security imaging with safety video surveillance, based on the detection of temperature measurement thresholds and generates a notification of an existing object.

In one embodiment the body temperature sensor provides a detector with Body temperature detection with infrared thermometer system to control terminal with face, palm vein and body temperature of a person to help prevent exposure and contribute to protecting the public and eliminate hygiene concerns. The system generates an alarm based on the detection of temperature measurement thresholds, when a person's body temperature is above normal (37.3° C.).

Multi sensing detector unit 11 may further include motion sensing, heat sensing, pressure sensing, noise sensing, or other types of sensing capabilities that combine with artificial intelligence of the central server or cloud-computing system 210 to detect the presence, movement, and/or identity of a person.

Referring to FIGS. 2A, 2B and 3 again The camera is specifically enabled with dual-light mode supports 3 modes for option: infrared, star light, and smart dual-light. The camera further has the following options:

Support 2DNR/3DNR image technology;
Support Extra-ISP night-vision;
Support 3 image Scenes modes: Transparent, Bright, Standard for option;
Night “dark area perception algorithm”, which increases the visibility of objects in dark parts of the image by 50% but won't affect the exposure of bright areas;
“Balanced Exposure Engine” at night to balance the exposure of the near and far images when people and cars are approaching. The exposure of the near faces is better suppressed and the visible distance of the distant scenery is more about 5M than others;
Support manual shutter and exposure adjustment—it's dear to see the contents of the electronic screen, LED screen, and
Support humanoid metering, after opening, the image will control the exposure of the humanoid area on priority to ensure that this area is clearer.

Unlike most of other devices which are basically limited to identify the person with a short-range video detection, these features enable the present invention to free from this limitation and can be installed at big retail chains and many more places to identify the customer's behavior pattern along with the live CCTV feed. Other devices perform only facial lock features, but the present invention can perform the attendance with the facial lock access and even the KYC of customers in banks with facial recognition.

In the smart-home environment 100 all smart devices may be communicatively coupled to each other and to central server or cloud-computing system 210. In addition each of the smart devices may be capable of data communications with any other of the network-connected smart devices. The present invention 10 has the capability to integrate for example with the fire alarm or any other real time emergency which allows device to immediately notify the nearest police, fire, and rescue team along with the owner.

Various additional functions can be utilized through the wireless terminal such as a smart phone. A wireless terminal such as smart phone can be interworked wirelessly and in this case the system can be utilized without restriction of distance by using a smart phone. For example, when a door lock is required to be opened or closed from outside, it is possible to control the system conveniently through the interlocking of the smartphone and the system. The users can edit data and have access to the pictures uploaded in the device with the phone after the approval of the admin. The phone of the device can be installed at door, in wardrobes, safe etc. for more security.

The multifunction smart door lock 10 has the capability of being integrated with fire alarm and security smart home system 100 and creating personalized experience for each user based on their specific preferences. With real-time remote monitoring and alarming, the system can generate real-time remote monitoring and access door alarms and alarms as needed.

In one embodiment the multi-sensing detector unit 11 is equipped with a pressure sensor by sensing pressure variation patterns associated with activities in front of the door. The cloud-computing system 210, upon reviewing the pressure variation, can determine the activity to indicate that an object is in front of the door or approaching the door. Smart doors 110 may have any other suitable sensors or technology to detect suitable information associated with the smart door 110.

Various types of notices and other information may be provided to the user via messages sent to the user's devices. It should be appreciated that these messages can be sent via email, short message service (SMS), multimedia messaging service (MMS). It may also include message alarm and also sending proper live feed to the user and notify the user.

In another embodiment the multi-sensing detector unit 11 further has an audio sensor (e.g., a microphone, which may operate in conjunction with an audio-processing application that may be accessible to smart door 110 (e.g., at smart home environment 100 or computing platform 200), which may identify a particular voice or other specific audio data for authenticating a user or for any other suitable purpose through a suitable voice analyzer. In one embodiment a speaker or a virtual speaking device may further provide which greets people on arrival/departure and specific occasion along with the basis of available data. This provides the capability to speak to the unknown visitor such as delivery agents etc. with even a long distance via phone enabled feature.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A multifunction door lock system for detection and control securely and effectively the entry of a person through a passageway, the system comprising:
a facial detecting means to detect, based on facial image data whether the person attempting to pass through said passageway is or is not authorized to pass;
a multi-sensing detecting means to sense the existence of a person or an object approaching the door;
a data recording means to record facial data in advance;
wherein said facial detecting means detects the authorized person at the passageway by comparing said on-site facial image data taken by a camera with the recorded facial data in said data recording means.

2. The system according to claim 1, wherein the facial detecting means comprising:
an input unit;
a control unit to control the operation of the system;
an output unit;
a battery operated power source for operation of the various parts of the system, and
a door opening and closing unit.

3. The system according to claim 2, wherein the input unit comprising a key pad, an image input unit and a sensor unit.

4. The system according to claim 2, wherein the image input unit is at least a camera to:
capture one or more image of a person and generate an authentication approval to grant a permission for entry the door;
detect motion of an object and in response to detecting motion analyze at least one or more captured images to determine a presence of a person;
analyze captured images to determine whether the person is authorized or unauthorized with respect to the multifunction smart door lock system.

5. The system according to claim 4, wherein the camera is a Raspberry Pi camera with a microcontroller.

6. The system according to claim 4, wherein the camera has a dual-light mode supports 3 modes for option: infrared, star light, and smart dual-light.

7. The system according to claim 4, wherein at least a camera has a support 2DNR/3DNR image technology; support Extra-ISP night-vision, and support 3 image Scenes modes in transparent, bright and Standard.

8. The system according to claim 4, wherein at least a camera has a night dark area perception algorithm to increases the visibility of objects in dark parts.

9. The system according to claim 4, wherein at least a camera has a balanced exposure engine at night to balance the exposure of a near and far images.

10. The system according to claim 2, wherein the output unit is a touchscreen or touchless LCD display.

11. The system according to claim 1, wherein said multi-sensing detecting means comprising:
at least a temperature sensor; a motion sensor; a heat sensor, a pressure sensor and an audio sensor to detect the presence of an object.

12. The system according to claim 11, wherein said temperature sensor is an infrared thermometer system with thermal imaging temperature detection.

13. The system according to claim 11, wherein said pressure sensor in conjunction with said camera sense a pressure variation pattern to determine the activity of an object in front of a door or approaching a door.

14. The system according to claim 11, wherein the audio sensor has a voice analyzer for authenticating a user through an audio data.

15. The system of claim 11, wherein the motion sensor having various sensor integrated in said camera for viewing an approach of a person and detecting motion and analyze with respect to captured images to determine a presence of a person.

16. The system according to claim 2, wherein the door opening and closing unit is a servomotor to actuate the door opening and closing.

17. A non-transitory computer readable storage medium storing one or more programs, the one or more programs comprising instructions, which, when executed by a computing system comprising one or more processors and one or more sensors and a door opening and closing unit cause the computing system to detect and control securely and effectively the entry of a person through a passageway.

18. The method for detection and control securely and effectively the entry of a person through a passageway comprising:
capturing an image of a face as an on-site facial image by a camera;
detecting an authorized person by comparing said on-site facial image taken currently with a previously taken facial image data recorded in a data recording means;
comparing said image with the threshold value to determine the final recognition result;
processing the face image to meet the feature extraction requirement;
requesting to enter a passcode on a display unit;
comparing a user information with pre-stored identity in the database of the system;
allowing of passage for said authorized person, and
denying of passage for said unauthorized person.
